(19) United States
(12) Patent Application Publication
(10) Pub. No.: US 2026/0094357 A1
(43) Pub. Date: Apr. 2, 2026

(54) DYNAMIC NOVEL VIEW RECONSTRUCTION BASED ON FLOW REMATCHING

(71) Applicant: NVIDIA Corporation, Santa Clara, CA (US)

(72) Inventors: Matan Atzmon, Toronto (CA); Sanja Fidler, Toronto (CA); Sara Oblak, Zurich (CH); Despoina Paschalidou, Mountain View, CA (US)

(73) Assignee: NVIDIA Corporation, Santa Clara, CA (US)

(21) Appl. No.: 18/915,547

(22) Filed: Oct. 15, 2024

(30) Foreign Application Priority Data
Sep. 30, 2024 (GR) 20240100666

(51) Int. Cl. G06T 15/20; G06T 7/20

(52) U.S. Cl. CPC G06T 15/205; G06T 7/20; G06T 2207/20084

(57) ABSTRACT

Various examples, systems, and methods are disclosed relating to dynamic novel view reconstruction based at least in part on flow rematching. A first computing system can cause an image rendering model to generate an estimated image of a scene based at least on a plurality of images of the scene. The at least one image of the plurality of images can be with at least one of a different time or a different view. The first computing system can update the image rendering model based at least on the estimated image, the plurality of images, and/or one or more criteria for motion associated with the estimated image.

### CROSS-REFERENCE TO RELATED APPLICATIONS

The present applications claims the benefit of and priority to Greece Patent Application Serial No. 20240100666, filed Sep. 30, 2024, the disclosure of which is incorporated herein by reference in its entirety.

### BACKGROUND

Systems for novel-view dynamic reconstruction often use static scene representations, which can be limited in effectively rendering content and objects having complex deformations or rapid changes in motion. Techniques such as voxel-based methods or static mesh models have a restricted capacity to represent dynamic aspects of scenes, particularly when input data is sparse, temporally inconsistent, or captured from varying viewpoints. These limitations can result in artifacts, inaccuracies in motion depiction, and increased computational load, especially in applications requiring real-time or near real-time scene rendering. For example, conventional methods cannot adequately depict interactions of deformable objects, leading to visually inconsistent outputs and increased latency in dynamic environments such as augmented reality, robotic vision, or autonomous navigation systems.

### SUMMARY

Implementations of the present disclosure relate to systems and methods for dynamic scene reconstruction that incorporate flow rematching techniques to improve modeling of complex deformations over time. Systems and methods are described that integrate models, such as Gaussian splatting and neural radiance fields (NeRF), with velocity field determinations to improve the accuracy of reconstructed views. These techniques facilitate alignment of estimated motion fields with observed data, supporting accurate rendering of scenes captured from multiple viewpoints or at different time intervals. For example, systems and methods in accordance with the present disclosure can iteratively refine velocity fields to better represent interactions of dynamic objects, reducing discrepancies between the reconstructed flow and actual motion patterns. This approach can support accurate and computationally efficient scene reconstruction, such as under conditions of sparse or temporally inconsistent input data, improving performance and reliability of dynamic vision-based systems.

Some implementations relate to one or more processors including processing circuitry. The processing circuitry cause an image rendering model to generate an estimated image of a scene based at least on a plurality of images of the scene. In some implementations, at least one image of the plurality of images is associated with at least one of a different time or a different view. The processing circuitry update the image rendering model based at least on the estimated image, the plurality of images, and/or one or more criteria for motion associated with the estimated image.

In some implementations, the one or more criteria for motion include a velocity field representing a plurality of deformations in space over time. In some implementations, updating the image rendering model further includes rematching a velocity field generated from the estimated image with a prior velocity field corresponding to/with the scene. In some implementations, the one or more criteria for motion include at least one of (i) a rigidity constraint that limits changes in shape of objects over time or (ii) a continuity constraint that assumes smooth transitions in object motion(s) within the scene.

In some implementations, the one or more criteria for motion correspond to a machine learning (ML) model trained/updated to generate one or more deformations of the estimated image based on parameters derived from one or more historical scenes. In some implementations, the one or more processors including processing circuitry are to determine the one or more criteria for motion based at least on an output of a minimization of one or more functions satisfying the at least one of (i) the rigidity constraint, (ii) the continuity constraint, or (iii) a constraint derived from the ML model.

In some implementations, the image rendering model includes at least one of (i) a Gaussian splatting model or (ii) a neural radiance field (NeRF) model. In some implementations, the plurality of images of the scene includes a plurality of multi-view images. In some implementations, the plurality of multi-view images corresponds to a plurality of different viewpoints captured at a plurality of different time points. In some implementations, the one or more processors including processing circuitry are to apply a scene reconstruction using the image rendering model to render the estimated image for one or more viewpoints and temporal intervals based on the plurality of images of the scene.

In some implementations, updating the image rendering model includes minimizing a reconstruction loss and/or a rematch loss. In some implementations, the reconstruction loss corresponds to a measure of discrepancy between the estimated image and the plurality of images of the scene. In some implementations, the rematch loss corresponds to a measure of deviation between the estimated image and the one or more criteria for motion associated with an image flow.

Some implementations relate to a system. The system can include one or more processors to execute operations including causing an image rendering model to generate an estimated image of a scene based at least on a plurality of images of the scene. In some implementations, at least one image of the plurality of images associated with at least one of a different time or a different view. The system can include one or more processors to execute operations including updating the image rendering model based at least on the estimated image, the plurality of images, and one or more criteria for motion associated with the estimated image.

In some implementations, the one or more criteria for motion include a velocity field representing a plurality of deformations in space over time. In some implementations, updating the image rendering model further includes rematching a velocity field generated from the estimated image with a prior velocity field corresponding with/to the scene. In some implementations, the one or more criteria for motion include at least one of: (i) a rigidity constraint that limits changes in shape of objects over time, or (ii) a continuity constraint that assumes smooth transitions in object motion(s) within the scene. In some implementations, the one or more criteria for motion correspond to a machine learning (ML) model trained/updated to generate one or more deformations of the estimated image based on parameters derived from one or more historical scenes.

In some implementations, the one or more processors execute operations including determining the one or more criteria for motion based at least on an output of a minimization of one or more functions satisfying the at least one of: (i) the rigidity constraint, (ii) the continuity constraint, or (iii) a constraint derived from the ML model.

In some implementations, the image rendering model includes at least one of (i) a Gaussian splatting model or (ii) a neural radiance field (NeRF) model. In some implementations, the plurality of images of the scene includes a plurality of multi-view images, wherein the plurality of multi-view images corresponds to a plurality of different viewpoints captured at a plurality of different time points. In some implementations, the one or more processors execute operations including applying a scene reconstruction using the image rendering model to render the estimated image for one or more viewpoints and temporal intervals based at least on the plurality of images of the scene.

Some implementations relate to a method. The method includes causing, using one or more processors, an image rendering model to generate an estimated image of a scene based at least on a plurality of images of the scene. In some implementations, at least one image of the plurality of images associated with at least one of a different time or a different view. The method includes updating, using the one or more processors, the image rendering model based at least on the estimated image, the plurality of images, and one or more criteria for motion associated with the estimated image.

### BRIEF DESCRIPTION OF THE DRAWINGS

The present systems and methods for dynamic scene reconstruction in a reconstruction pipeline are described in detail below with reference to the attached drawing figures, wherein:

FIG. 1 is a block diagram of an example of a system, in accordance with some implementations of the present disclosure;

FIG. 2 is a flow diagram of an example of a method for dynamic novel view reconstruction based at least in part on flow rematching, in accordance with some implementations of the present disclosure;

FIG. 3A is an example of flow rematching using velocity fields, in accordance with some implementations of the present disclosure;

FIG. 3B is an example rendering of flow rematching using velocity fields, in accordance with some implementations of the present disclosure;

FIG. 4A is a block diagram of an example generative language model system for use in implementing at least some implementations of the present disclosure;

FIG. 4B is a block diagram of an example generative language model that includes a transformer encoder-decoder for use in implementing at least some implementations of the present disclosure;

FIG. 4C is a block diagram of an example generative language model that includes a decoder-only transformer architecture for use in implementing at least some implementations of the present disclosure;

FIG. 5 is a block diagram of an example computing device for use in implementing at least some implementations of the present disclosure; and

FIG. 6 is a block diagram of an example data center for use in implementing at least some implementations of the present disclosure.

### DETAILED DESCRIPTION

This disclosure relates to systems and methods for novel view dynamic reconstruction, such as systems and methods of view reconstruction based on flow rematching. Some systems can encounter technical limitations in reconstructing dynamic scenes from sparse and temporally inconsistent multi-view inputs, where images are captured at varying times or from different viewpoints. That is, the systems can fail to manage the complexities of synthesizing accurate intermediate views while preserving realistic motion and deformation patterns of objects within the scene. Some reconstruction models can rely on flow-based techniques, such as velocity fields (e.g., representing the motion of pixels or features across frames) to manage deformations, but such techniques can require integration, resulting in increased computational overhead and limited scalability. These reconstruction models can also rely on specific priors (e.g., learned motion patterns, shape constancy constraints, or any other constraints derived from historical scene data, laws of physics, or domain-specific information), which can restrict the effectiveness of the model to generalize across different types of dynamic scenes with varying motion patterns and deformation complexities.

Additionally, reconstruction models can also be constrained by technical problems in integrating multiple types of priors (e.g., physical constraints or learned models) within a model while maintaining reconstruction quality and generalization capabilities. That is, methods that rely on predefined physical priors or learned models can be deficient for managing deformations in dynamic reconstruction models, particularly for scenes with complex deformations or rapid changes.

Systems and methods in accordance with the present disclosure can provide a framework for novel view dynamic reconstruction that incorporates flow rematching techniques to address these technical problems. By determining flows that represent deformations and rematching these flows to the dynamic reconstruction model, the system can eliminate the requirement for a time step integration of velocity fields. That is, the framework allows for the incorporation of various priors (e.g., whether physical, such as rigidity or continuity, or derived from foundation models), while maintaining computational efficiency and improving reconstruction accuracy. The flow rematching process improves iterative refinement of the image rendering model to align reconstructed views with realistic motion patterns and reduce errors in synthesized images.

For example, the systems and methods can update an image rendering model by minimizing a combination of a reconstruction loss (L_{REC}) and a rematch loss (L_{RM}). That is, the reconstruction loss can be associated with comparing the estimated image with a plurality of images of the scene, at least one image captured at different times or viewpoints, to measure discrepancies between the estimated and reference images. Further, the rematch loss can be associated with matching an image flow represented in the estimated image with constraints that define the allowable motion based on criteria for motion, such as physical priors or learned motion models. Accordingly, the combination of the reconstruction loss and the rematch loss improves the performance of dynamic reconstruction models in capturing realistic motion patterns and synthesizing accurate intermediate views while reducing computational overhead.

In some implementations, the system can determine the criteria for motion based on the output of a minimization problem formulated to satisfy one or more constraints, such as a rigidity constraint, a continuity constraint, or a constraint derived from a machine learning model trained/updated on parameters extracted from historical scenes. The minimization process can be used to determine an optimal flow that satisfies the constraints. This process allows the model to adaptively update the scene representation without integrating velocity fields at one or more (e.g., each) time steps. As a result, the computational efficiency can be improved and training times can be reduced.

Additionally, the criteria for motion can be represented by a velocity field, such as to represent a plurality of deformations in space over time. The velocity field can be used to update the image rendering model by rematching the velocity field generated from the estimated image with a prior velocity field corresponding to the scene. For example, the criteria for motion can include at least one of a rigidity constraint or a continuity constraint, or can correspond to a machine learning model that is trained to generate deformations of the estimated image based on parameters derived from historical scenes. The image rendering model can further use a combination of a Gaussian splatting model or a neural radiance field (NeRF) model to process different types of scene representations. That is, the system can further enhance dynamic scene reconstruction by supporting multiple types of representations, such as Gaussian splats or NeRF models, or any learnable rendering model. For example, these representations can be selected based on the characteristics of the scene and the desired reconstruction quality. Additionally, the plurality of images of the scene can include multi-view images captured from different viewpoints at different time points.

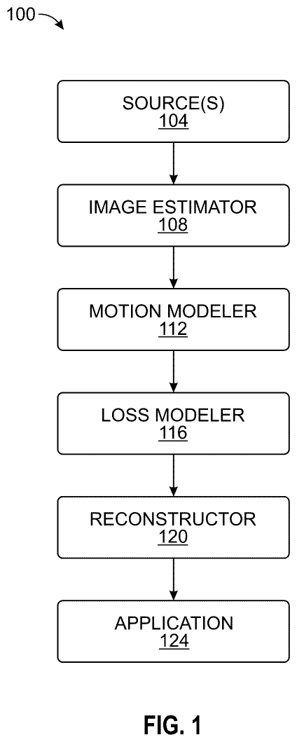

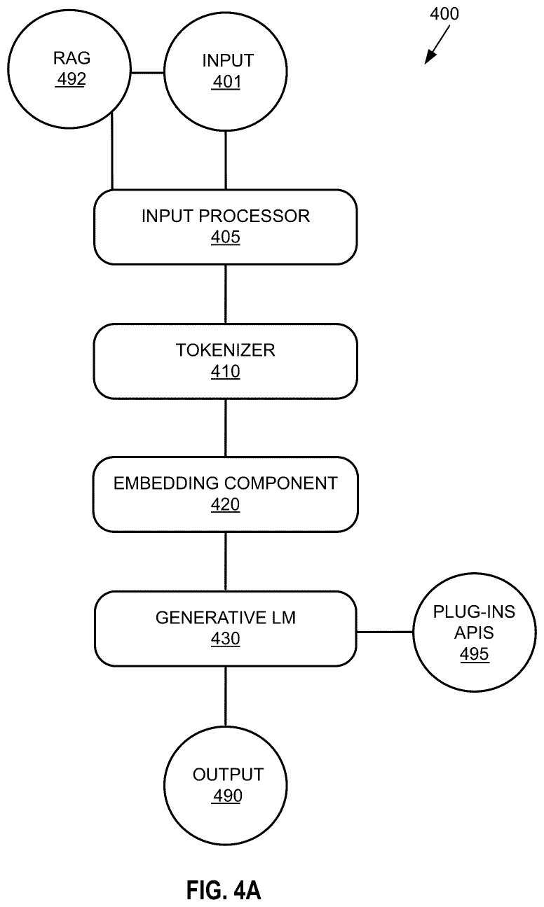

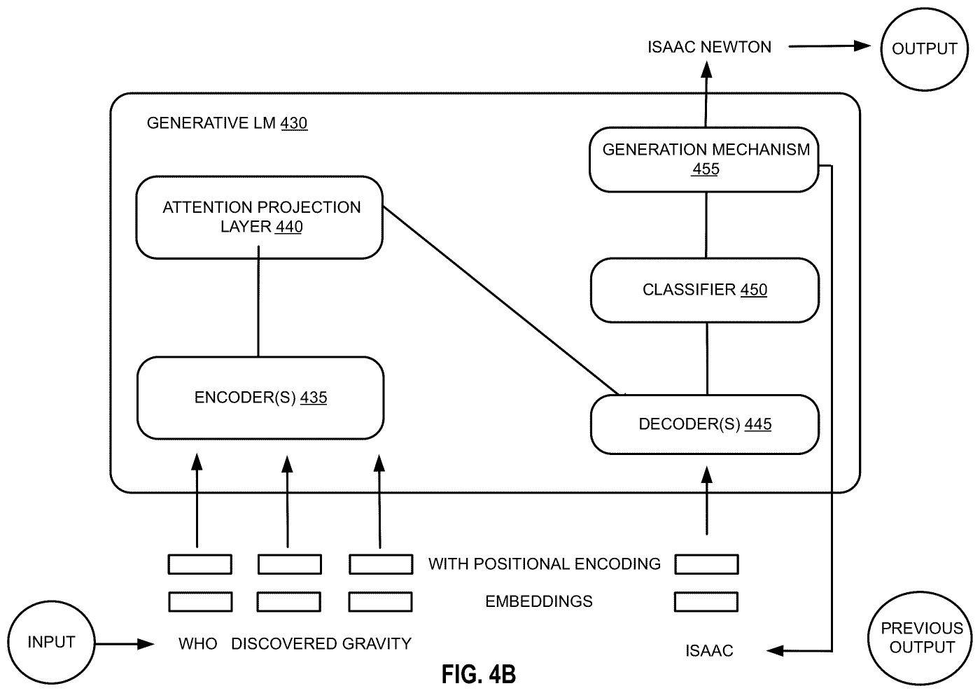

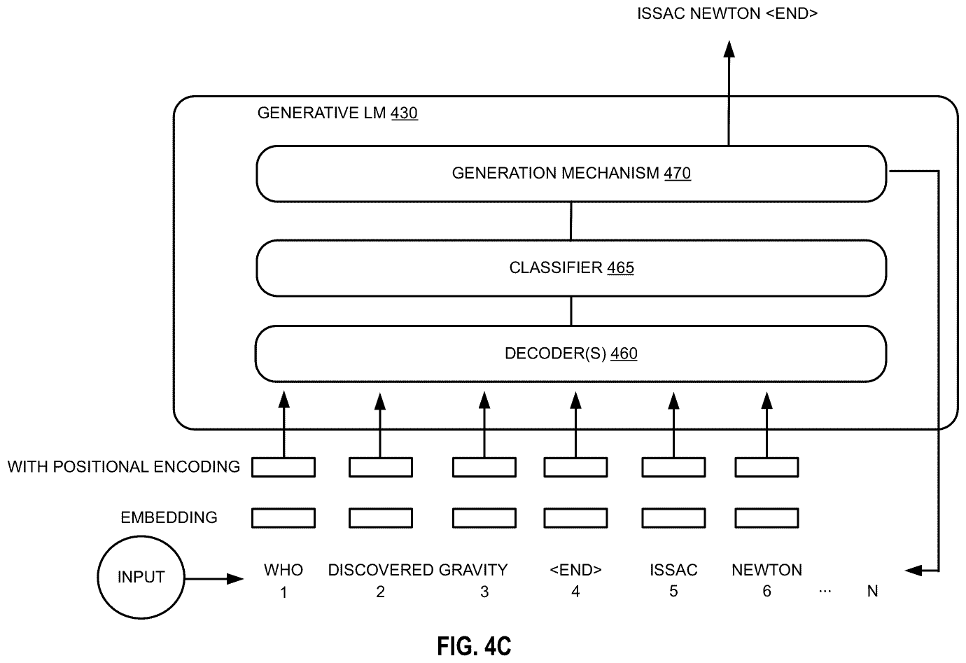

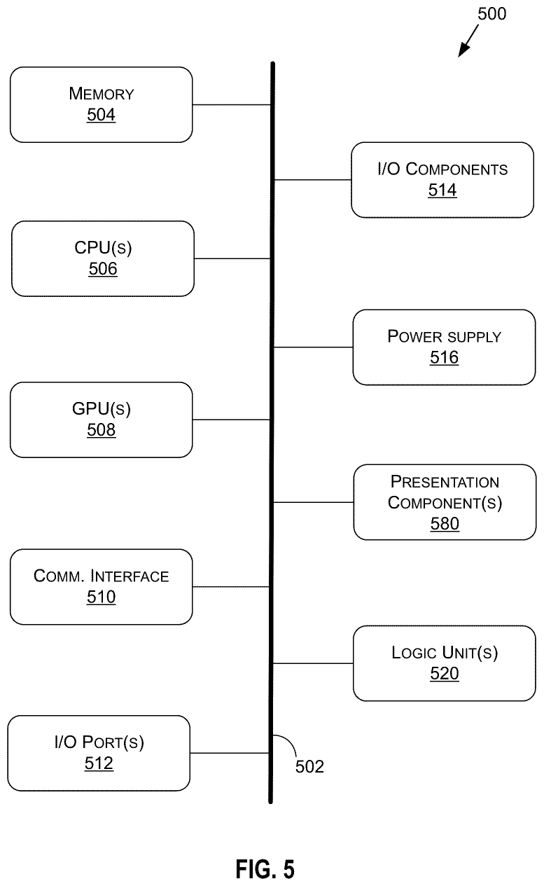

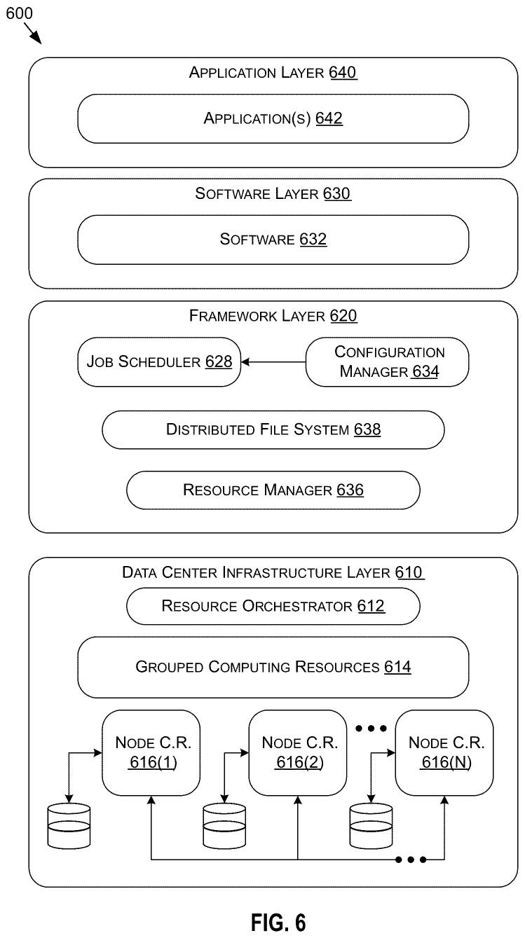

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 400 of FIG. 4A, example generative LM 430 of FIGS. 4B-4C, example computing device 500 of FIG. 5, and/or example data center 600 of FIG. 6.

The system 100 can implement at least a portion of an artificial intelligence (AI) pipeline, such as a reconstructor AI and/or reconstruction pipeline. For example, the system 100 can process data from one or more data sources representative of a scene and/or a plurality of images of the scene for tasks such as novel-view synthesis, dynamic scene reconstruction, and/or motion estimation. The system 100 can be used to generate data for further processing by any of various systems described herein, including but not limited to, autonomous vehicle systems, augmented reality systems, medical imaging systems, industrial automation systems, robotic vision systems, virtual reality systems, computer graphics systems, and/or security surveillance systems.

Generally, the reconstruction pipeline can include operations performed by the system 100. For example, the reconstruction pipeline can include any one or more of an estimator stage, a motion stage, a loss stage, and/or a reconstructor stage.

In some implementations, the system 100, implementing the reconstruction pipeline, can obtain and/or receive a collection of multi-view frames (Ft) taken along T time stamps t∈{t₁, . . . , t_{T}}, t₁=0< . . . <t_{T}=1, with at least one (e.g., each) frame including M images

$${F}_{t} = {\{ {I}_{i}^{t} \}}_{i = 1}^{M} .$$

The system 100 can use the collection of multi-view frames to train and implement an image model that facilitates novel-view image synthesis for general directions d∈S² and time t∈[t₁,t_{T}]. That is, the system 100 can use a novel-view reconstruction pipeline (also referred to herein as a “reconstruction pipeline”), which can be denoted as (Equation 1):

$$t ↦ {Ψ}_{t} = \{ {ψ}_{t} \vert ψ : {ℝ}_{+} \to V \}$$

where Ψₜ can be the rendering model, ψₜ can be a mapping function, the V of the functions ψ: [symbol] ₊→V can be a vector space. V can denote a different vector space for at least one (e.g., each) ψ. That is, V can represent different properties of the scene elements (e.g., positions, densities in varying dimensions). For example, ψ can be a time-dependent position of n particles representing a deforming geometry, V= [symbol] ^{n×d}. For example, ¿ can model time-dependent image intensity values for which V=C¹( [symbol] ^{d})={f|f: [symbol] ^{d}→ [symbol] , ∇f exists and continuous} with d=2.

In some implementations, a velocity field can be a time-dependent function (Equation 2):

$$v : {ℝ}^{d} \times {ℝ}_{+} \to {ℝ}^{d}$$

where d (e.g., d=2 or d=3) can be the spatial dimensionality of the scene. That is, d=2 can correspond to 2D space, and d=3 can correspond to 3D space. The velocity fields can define deformations (also referred to as “flows”) in space φₜ: [symbol] ^{d}→ [symbol] ^{d} by an Ordinary Differential Equation (ODE) (Equation 3):

$$\{ \begin{matrix}\frac{\partial }{\partial t} t ( x ) = v ( {ϕ}_{t} ( x ) , t ) \\ {ϕ}_{0} ( x ) = x\end{matrix}$$

The system 100 can be incorporated (e.g., into a dynamic reconstruction pipeline) using dynamic reconstruction by transporting a particle x in space along a curve, x(t)=φₜ(x). That is, the transportation can model time-dependent deformations. For example, when the underlying scene representation can be particle-based controlled (e.g., as in explicitly geometry described by a point cloud), φₜ(x) can be applied for at least one (e.g., each) geometry element to model the deformation in time. That is, a flow can also be used to define a time-dependent function ψₜ: [symbol] ^{d}→ [symbol] ^{d} by using a reference function, ψₒ (e.g., ψₜ=φₜ*ψₜ). For example, d=2 for image intensities and/or d=3 for volume density.

Additionally, incorporating flows can include the system 100 determining φₜ(x), which can be (Equation 4):

$${ϕ}_{t} ( x ) = x + {\int }_{0}^{t} v ( {ϕ}_{s} ( x ) , s ) d s$$

where x can be an initial position of the particle, v can be the velocity field representing deformations, and s can be a time variable representing the integration bounds. That is, Equation 4 can be used to model the trajectory of the particle over time. In some implementations, the φₜ(x) can be determined for at least one (e.g., each) evaluation of the model during training and inference. Oftentimes, determining the φₜ(x) can inhibit the training of flow-based models from converging to solutions representative of expressing complex deformations, making it a computationally inefficient method in dynamic reconstruction pipelines.

In some implementations, at least one time-dependent reconstruction function ψ∈Ψ can induct a flow that matches ψₜ and can be determined using ψₜ and its corresponding partial derivative(s). That is, a flow induced by ψₜ can be a reconstruction flow, represented by φₜ. Additionally, φₜ generating velocity field can be a reconstruction velocity field, represented by v. In some implementations, the system 100 can use Equation 3 to determine a constraint on generating velocity field v in relation to ψₜ. That is, the constraint can ensure that the velocity field v conforms to the dynamics provided by ψₜ. For example, V= [symbol] ^{n×d} where ψ can include n curves, ψ={γⁱ} for which at least one (e.g., each) γⁱ can match a curve of a reconstruction flow starting at

$${γ}_{0}^{i} .$$

That is, a constraint on generating the velocity field can be (Equation 5):

$$v ( {γ}_{t}^{i} , t ) = \frac{d}{d t} {γ}_{t}^{i} , ∀ 1 \leq i \leq n$$

Additionally, for example, where ψ: [symbol] ₊→C¹( [symbol] ^{d}), a reconstruction flow can be determined using additional determinations on v. That is, Equation 5 can be used to maintain consistency in ψₜ with the divergence constraints induced by v. In this example, ψₜ can be quantified by determining ψₜ can be a push forward of ψ₀ by φₜ for which ψₜ can be locally conversed in time, a continuity equation can be used to determine a constraint on φₜ (Equation 6):

$$\frac{\partial }{\partial t} {ψ}_{t} ( x ) + d i v ( {ψ}_{t} ( x ) v ( {ψ}_{t} ( x ) , t ) ) = 0 , ∀ x ∈ {ℝ}^{d}$$

Additionally, the div(ψₜ(x)v(ψₜ(x),t) can be equal to [symbol] ∇ₜ(x),v(ψₜ(x),t [symbol] +div(c). Thus, a reconstruction velocity field (v) can include a plurality of degrees of freedom. That is, the constraints provide multiple degrees of freedom for determining the velocity field.

In some implementations, to model and/or facilitate flow rematching the system 100 can determine a velocity field u: [symbol] ^{d}× [symbol] ₊, that can match v. That is, the constraint aligns u with the expected formations described by ψₜ. Additionally, since u can also incorporate some prior about the underlying possible deformations, u can be restricted to a prior class of velocity fields denoted by P. The constraints on v in terms of ψₜ can facilitate a flow matching optimization function by using u in Questions 5 and 6, shown below (Equation 7):

$$u = arg {min}_{u ∈ P} {\int }_{0}^{1} ρ ( u ( \cdot , t ) , {ψ}_{t} ) dt$$

where ρ can be either (Equation 8)

$${ρ}_{I} ( u ( \cdot , t ) , {ψ}_{t} ) = {\sum }_{i = 1}^{n} {‖ u ( {γ}_{t}^{i} , t ) - \frac{d}{dt} {γ}_{t}^{i} ‖}^{2}$$

### or can be (Equation 9):

$${ρ}_{II} ( u ( \cdot , t ) , {ψ}_{t} ) = \int {\vert \frac{\partial }{\partial t} {ψ}_{t} ( x ) + div ( {ψ}_{t} ( x ) u ( x ) , t ) \vert}^{2} dx$$

Additionally, the solution for u can be the closest (e.g., minimizing discrepancy, best-fit projection) projection of the reconstruction flow P. That is, alignment can be determined between u and the construction flow. In some implementations, the integral of Equation 7 can be approximated by a sum analyzed on a random draw of {t₁}˜U[0,1].

In some implementations, given u E P from Equations 7-9, u can be used to control the underlying reconstruction flow. That is, a flow rematching loss, L_{RM}, a flow matching loss (e.g., the reconstruction flow) attempting to rematch u. L_{RM} can be defined as (Equation 10):

$${L}_{R M} ( θ ) = {\int }_{0}^{1} ρ ( u ( \cdot , t ) , {ψ}_{t} ) dt$$

where θ can be the parameters of ψₜ. The rematch loss L_{RM} can be used with a reconstruction loss, L_{REC} on ψ parameters of θ to obtain a final loss (Equation 11):

$$L ( θ ) = {L}_{R M} ( θ ) + λ {L}_{R E C} ( θ )$$

where λ>0 can be a tuned hyper-parameter.

In some implementations, the system 100 can apply the above Equations (e.g., Equations 1-11) to a Gaussian Splats (or any neural representation) rendering model. For example, a Gaussian Splats image model can be parameterized by a collection of 3D Gaussians augmented with color and opacity parameters

$${\{ {μ}^{i} , {\sum }^{i} , {c}^{i} , {α}^{i} \}}_{i = 1}^{n}$$

with μⁱ∈ [symbol] ³ denoting the i^{th} Gaussian mean, Σⁱ∈ [symbol] ^{3×3} can be the covariance matrix, cⁱ∈ [symbol] ³ can be the project color, and αⁱ∈ [symbol] can be the opacity. The 3D Gaussians can be projected to the image plane to form a collection of image plan Gaussians parameterized by

$$\{ {μ}_{2 D}^{i} , {\sum }_{2 D}^{i} \} .$$

Given K, E denoting the intrinsic and extrinsic camera transformations, the system 100 can determine the image plane Gaussian parameters using a point rendering formula. The 3D gaussian center can be projected by (Equation 12):

$${μ}_{2 D} = K \frac{E μ}{{( E μ )}_{z}}$$

and covariance matrix can be projected by (Equation 13):

$${\sum }_{2 D} = JE \sum {E}^{T} {J}^{T}$$

where J denotes the Jacobian of the affine transformation of Equation 12). That is, Equation 12 can be used to determine the position of the 2D projection and Equation 13 can be used to determine the shape and orientation of the 2D Gaussian in the image plane.

Additionally, an image pixel I(p) can be obtained by the system 100 performing alpha-blending on the (ordered by depth) visible Gaussians (Equation 14):

$$I ( p ) = {\sum }_{i = 1}^{n} {c}^{i} {α}^{i} {σ}^{i} ( p ) {\prod }_{j = 1}^{i - 1} ( 1 - {α}^{j} {σ}^{j} ( p ) )$$

where

$${σ}^{i} ( p ) = exp ( - \frac{1}{2} {( p - {μ}_{2 D}^{i} )}^{T} {( {\sum }_{2 D}^{i} )}^{- 1} ( p - {μ}_{2 D}^{i} ) ) .$$

That is, Equation 14 can be used to model the blending of multiple Gaussians based on the depth ordering and visibility (e.g., output a composite pixel intensity in the rendered image).

Additionally, a time-dependent Gaussian splat can be a model of the form

$${\{ {μ}^{i} ( t ) , {\sum }^{i} ( t ) , {c}^{i} ( t ) , {α}^{i} ( t ) \}}_{i = 1}^{n} .$$

For example, {μⁱ(t)} can conform to the parametrization of the framework with V= [symbol] ^{3×3}, ψ={μⁱ(t)}. That is, the framework can define the Gaussian parameters as time-varying functions that change within the specified vector space (e.g., representing dynamic spatial transformations of scene elements over time).

In some implementations, when φ=μ(t) is used to model Gaussian centers, the velocity field v_{*}(·,t) can be obtained by minimizing the squared error between the velocity field and the time derivative of the Gaussian centers (Equation 15):

$${v}_{*} ( \cdot , t ) = arg {min}_{v ∈ 𝒞} \int {‖ v ( μ ( t ) , t ) - \dot{μ} ( t ) ‖}^{2} d μ$$

where v_{*} can be the optimal (or desired) velocity field, v can be any candidate velocity field within the constraint set [symbol] , [symbol] can be a set of velocity fields satisfying specific deformation constraints, μ can be the Gaussian center positions, \dot{μ} can be the time derivative of the Gaussian centers.

Additionally, to supervise the time-dependent reconstruction model, the function shown below can be used (Equation 16):

$$L = \int \int {‖ {v}_{*} ( μ , t ) - \dot{μ} ‖}^{2} d μ dt$$

where L can be the loss function used to minimize the discrepancy between the predicted and the actual motion of the Gaussian centers. That is, Equation 16 can model (or measure) the alignment of the velocity field with the true motion of the Gaussian centers over both space and time.

In some implementations, the [symbol] can model various deformations. For example, rigid deformations can be modeled by (Equation 17):

$$𝒞 = \{ v : {ℝ}^{3} \times ℝ \to {ℝ}^{3} \vert v ( x , t ) = A x + b , A ∈ {ℝ}^{3 \times 3} , A = - {A}^{T} , b ∈ {ℝ}^{3} \}$$

where the output can be a constrained least squares problem (e.g., solving for A and b that best fit the rigid motion constraint for Equation 15) for solving Equation 15. That is, Equation 17 can be used to enforce the rigid body constraint by restricting the form of the velocity field to linear transformations preserving volume.

In some implementations, multiple rigid motions can be modeled by (Equation 18):

$$𝒞 = \{ v \vert v ( x , t ) = {\sum }_{j = 1}^{K} {w}_{j} ( x , t ) ( {A}_{j} x + {b}_{j} ) , {A}_{j} ∈ {ℝ}^{3 \times 3} , {A}_{j} = - {A}_{j}^{T} , {b}_{j} ∈ {ℝ}^{3} \}$$

where wⱼ(x,t) can be weights for at least one (e.g., each) rigid motion component, Aⱼ and bⱼ can be the rigid transformations, and [symbol] facilitates a combination of multiple rigid transformations. That is, Equation 18 allows the modeling of one or more complex motions (e.g., articulated movements, deformable object transformations, multi-part object dynamics) by superimposing multiple rigid body transformations, weighted by wⱼ(x,t).

Additionally, u in Equations 7-11 can refer to a candidate velocity field that attempts to match the reconstruction flow as defined by constraints ψₜ. For example, in Equations 7-9, u can find the optimal u that minimizes a flow-matching loss function with respect to the target flow (e.g., reconstruction flow). The optimization process can project u onto a prior class of velocity fields P to satisfy the constraints defined by the dynamic scene reconstruction framework. In some implementations, v and v_{*} in Equations 15-18 can refer to the actual velocity field governing the motion of deformation of specific elements within the reconstruction model. That is, v can be optimized to match the derivative of the Gaussian center positions \dot{μ}(t), where v_{*} can be the optimal velocity field resulting from the optimization. Thus, u can be used to provide an approximation or candidate velocity field that matches the underlying constraints derived from ψₜ and v can be used to model and control the motion of Gaussian splats or other scene elements in space (e.g., derived and supervised by specific constraints on the motion of the object, such as matching \dot{μ}(t)).

The system 100 can include at least one image estimator 108. In some implementations, the estimator stage can refer to the stage in the reconstruction pipeline in which the image estimator generates an initial estimated image of the scene based on the input images using an image rendering model. The image estimator 108 at the estimator stage can cause an image rendering model to generate an estimated image of a scene based at least on a plurality of images of the scene, at least one image of the plurality of images associated with at least one of a different time (e.g., captured at different time steps t₁ and t₂ to represent temporal changes in the scene) or a different view (e.g., captured from different camera positions to provide multiple perspectives). That is, the image estimator 108 can use these different images to create an estimated image that represents the scene by integrating information from varying times or viewpoints. For example, estimating can include combining features from the input images to generate a view of the scene that regards the spatial and temporal changes captured. In this example, the image estimator 108 can use parameters derived from the input images, such as position data and transformations

$${μ}_{i}^{t}$$

and transformations defined in Equations 12 and 13, to map the scene elements in the estimated image. Additionally, the image estimator 108 can be configured to use different resolutions or inconsistencies in the input images to output a smooth and accurate estimated image. The estimator stage can create the initial estimate as a foundational image for further processing and refinement. For example, the image estimator 108 can generate an estimated image that aligns with the expected scene structure without performing full flow-based deformations. For example, the image estimator 108 can use information about the captured viewpoints to correct for perspective distortions in the initial estimated image.

In some implementations, the image estimator 108 can maintain, execute, train, and/or update one or more machine-learning models during the estimator stage. In some implementations, the machine-learning model(s) can include any type of predictive models capable of estimating initial scene representations based on input data. For example, the machine-learning model(s) can be trained and/or updated to identify correlations between images taken at different times or views to improve estimation accuracy. The machine-learning model(s) can be or include a transformer-based model (e.g., a generative pre-trained/updated transformer (GPT) model), a convolutional neural network (CNN) for image feature extraction, a recurrent neural network (RNN) for temporal pattern recognition, or any graph neural network (GNN) for modeling relationships between multi-view inputs. The machine-learning model(s) can be or include a variational autoencoder (VAE) model in some implementations. The image estimator 108 can execute the machine-learning model to generate outputs (e.g., initial scene estimates, adjusted view predictions, or image corrections based on input variability). The image estimator 108 can receive data to provide as input to the machine-learning model(s), which can include multi-view images, scene metadata, and/or preprocessed feature maps.

The image estimator 108 can include any one or more artificial intelligence models (e.g., machine learning models, supervised models, neural network models, deep neural network models), rules, heuristics, algorithms, filters (e.g., Kalman filters), functions, or various combinations thereof to perform operations including generating initial scene estimates, identifying image features and inconsistencies in input data, such as combining multi-view images to generate an estimated image that represents the scene structure. In some implementations, the image estimator 108 can be trained/updated independently from other systems or devices described herein (e.g., motion modeler 112, loss modeler 116, and/or reconstructor 120). In some implementations, training of the at least one image estimator 108 can be at least partially performed jointly with the training of the motion modeler 112, loss modeler 116, and/or reconstructor 120. In some implementations, the image estimator 108 can output one or more estimated images of a scene (e.g., initial estimates of the scene, corrected multi-view composites, or preliminary reconstructed views). For example, the image estimator 108 can generate an estimated image by integrating spatial and temporal features from multiple input images to create a view of the scene. For example, the image estimator 108 can use learned models for variations in input data, such as different lighting conditions or occlusions. In some implementations, the estimated images can be provided to the other systems or devices described herein. That is, the image estimator 108 can be a source of initial scene estimates for further refinement and processing. For example, it can provide the estimated images to the motion modeler 112, loss modeler 116, and/or reconstructor 120 for further processing and alignment with additional scene information.

The system 100 can include at least one motion modeler 112. In some implementations, the motion stage can refer to the stage in the reconstruction pipeline in which the motion modeler 112 determines and applies criteria for motion, such as constraints or learned models, to describe the movement and deformation of scene elements over time. The motion modeler 112 at the motion stage can determine the one or more criteria (e.g., learnable model) for motion based on an output of a minimization (e.g., minimization problem satisfying constraints) of one or more functions (e.g., cost, loss, or objective function) including at least one of: (i) the rigidity constraint, (ii) the continuity constraint, or (iii) a constraint derived from the ML model. For example, the criteria can be used to guide one or more dynamic reconstructions of the scene (e.g., at the loss stage). In this example, the criteria for motion can include a velocity field representing a plurality of deformations in space over time (e.g., Equation 4 used to represent particle trajectories based on integrated velocity fields). That is, the one or more criteria for motion can include at least one of: (i) a rigidity constraint that limits changes in shape of objects over time or (ii) a continuity constraint that assumes smooth transitions in object motion(s) within the scene. For example, determining criteria can include performing a minimization problem to determine the motion parameters that satisfy the defined constraints. In this example, the motion modeler 112 can output corrected motion fields based on the calculated criteria. For example, determining criteria can include using predefined models to predict scene dynamics and update motion parameters accordingly.

Generally, the criteria for motion can be implemented as a flow without requiring a flow integration. That is, the motion modeler 112 can determine the motion criteria from the defined constraints (e.g., rigidity or continuity) or learned models. For example, the motion modeler 112 can calculate velocity fields representing deformation without needing to integrate the fields over time, reducing computational complexity. Additionally, the motion modeler 112 can update the motion criteria in response to changes in the scene, such as varying object trajectories or deformation behaviors.

Additionally, the motion modeler 112 can be configured to integrate (utilize and/or incorporate) and/or learned motion models that adapt to varying scene conditions. The motion stage can output motion constraints that align with the expected behavior of the scene elements. For example, the motion modeler 112 can generate velocity fields and deformation parameters for use in subsequent stages. For example, the motion modeler 112 can refine motion predictions using a combination of physical and learned models.

In some implementations, the motion modeler 112 can maintain, execute, train, and/or update one or more machine-learning models during the motion stage. In some implementations, the machine-learning model(s) can include any type of predictive models capable of analyzing dynamic scene data and estimating motion parameters. For example, the machine-learning model(s) can be trained and/or updated to learn motion constraints and update to new scene configurations. The machine-learning model(s) can be or include a transformer-based model (e.g., a generative pre-trained/updated transformer (GPT) model), a convolutional neural network (CNN) for extracting spatial features and correlations, a recurrent neural network (RNN) for capturing temporal sequences, or any graph neural network (GNN) for analyzing relationships between scene elements. The machine-learning model(s) can be or include a variational autoencoder (VAE) model in some implementations. The motion modeler 112 can execute the machine-learning model to generate outputs (e.g., velocity fields, motion constraints, or dynamic scene predictions). Motion modeler 112 can receive data to provide as input to the machine-learning model(s), which can include multi-view image sequences, motion priors, and scene metadata.

The motion modeler 112 can include any one or more artificial intelligence models (e.g., machine learning models, supervised models, neural network models, deep neural network models), rules, heuristics, algorithms, filters (e.g., Kalman filters), functions, or various combinations thereof to perform operations including motion estimation, constraint application, and flow prediction, such as estimating motion fields based on the scene constraints and inputs. In some implementations, the motion modeler 112 can be trained/updated independently from other systems or devices described herein (e.g., image estimator 108, loss modeler 116, and/or reconstructor 120). In some implementations, training of the least one motion modeler 112 can be at least partially performed jointly with the training of the image estimator 108, loss modeler 116, and/or reconstructor 120. In some implementations, the motion modeler 112 can output one or more criteria for motion (e.g., corrected velocity fields, deformation models, or motion parameters). For example, motion modeler 112 can generate velocity fields that align with the learned or predefined motion models. For example, the motion modeler 112 can dynamically update the velocity fields as new data becomes available (e.g., received, identified, and/or accessed). In some implementations, the criteria for motion can be provided to the other systems or devices described herein. That is, the motion modeler 112 can be a source of updated motion constraints for the loss modeling or reconstruction stages. For example, the motion modeler 112 can provide motion criteria to the loss modeler 116 for updating an image rendering model.

The system 100 can include at least one loss modeler 116. In some implementations, the loss stage can refer to the stage in the reconstruction pipeline in which the loss modeler 116 evaluates and improves the image rendering model by calculating and minimizing discrepancies between estimated and reference images. The loss modeler 116 at the loss stage can update the image rendering model based at least on the estimated image, the plurality of images, and one or more criteria for motion associated with the estimated image. For example, the loss modeler 116 can analyze (or model) a loss associated with comparing the estimated image with ground truth (e.g., L_{REC}) and a loss associated with matching image flow represented in the estimated image with constraints on image flow (e.g., L_{RM}) (as described with reference to Equations 10-11 and Equations 15-16). Additionally, Equations 12-14 and/or Equations 17-18 can be used for Gaussian Splats where the loss modeler 116 can minimize the discrepancy between projected Gaussian parameters and the observed data. That is, the loss modeler 116 can adjust the image model to align with actual (e.g., real-time or near real-time) scene data. For example, determining loss can include calculating the pixel-wise and flow-wise error between the estimated image and the input data. In this example, the loss modeler 116 can update the rendering model parameters to reduce one or both types of errors.

Additionally, the loss modeler 116 can be configured to dynamically adjust the weights of different loss components (e.g., L_{REC} and L_{RM}) during training. For example, the loss modeler 116 can determine a minimization problem to obtain optimized model parameters that best fit the scene constraints (e.g., using Equation(s) 10-11 and/or 15-16 to minimize combined losses). In this example, Equation(s) 10-11 and/or 15-16 can define how the loss modeler 116 adjusts the model based on discrepancies in image flow and reconstruction quality.

In some implementations, the loss modeler 116 can rematch the velocity fields to the estimated flow to refine the final model output. That is, the reconstruction loss can correspond to a measure of discrepancy between the estimated image and the plurality of images of the scene (e.g., ground truth images, and/or any other reference data) and the rematch loss can correspond to a measure of deviation between the estimated image and the one or more criteria for motion associated with an image flow (e.g., criterion used for determining motion in scene reconstruction).

In some implementations, the loss modeler 116 can maintain, execute, train, and/or update one or more machine-learning models during the loss stage. In some implementations, the machine-learning model(s) can include any type of supervised or unsupervised models capable of learning loss functions for dynamic scene reconstruction. For example, the machine-learning model(s) can be trained and/or updated to learn a loss functions that can balance (or weight in proportion) reconstruction quality and motion alignment. The machine-learning model(s) can be or include a transformer-based model (e.g., a generative pre-trained transformer (GPT) model), a convolutional neural network (CNN) for learning image representations, a recurrent neural network (RNN) for modeling temporal dependencies in loss evolution, or any graph neural network (GNN) for identifying relationships in scene data. The machine-learning model(s) can be or include a generative adversarial network (GAN) model in some implementations. The loss modeler 116 can execute the machine-learning model to generate outputs (e.g., updated loss values, updated model parameters, or refined scene reconstructions). The loss modeler 116 can receive data to provide as input to the machine-learning model(s), which can include image estimates, ground truth data, and calculated motion fields.

The loss modeler 116 can include any one or more artificial intelligence models (e.g., machine learning models, supervised models, neural network models, deep neural network models), rules, heuristics, algorithms, filters (e.g., Kalman filters), functions, or various combinations thereof to perform operations including loss calculation, model updating, and error minimization, such as calculating combined losses (e.g., L_{REC} and L_{RM}) to update the image model parameters. In some implementations, the loss modeler 116 can be trained/updated independently from other systems or devices described herein (e.g., motion modeler 112, image estimator 108, and/or reconstructor 120). In some implementations, training of the at least one loss modeler 116 can be at least partially performed jointly with the training of the motion modeler 112, image estimator 108, and/or reconstructor 120. In some implementations, the loss modeler 116 can update the image rendering model such that the estimated image better aligns with the input data and defined motion constraints. For example, the loss modeler 116 can refine the image parameters to reduce visual and flow errors based on the defined loss functions. For example, the loss modeler 116 can use the updated parameters to improve reconstruction quality in dynamic scenes.

In some implementations, the updated image rendering model can be implemented (e.g., used for inference) with other systems or devices described herein. That is, the reconstructor 120 can use the updated model parameters to generate novel view images that are consistent with the input scene data. For example, the reconstructor 120 can render scene elements based on the updated model parameters facilitated by the loss modeler 116.

The system 100 can include at least one reconstructor 120. In some implementations, the reconstructor stage can refer to the stage in the reconstruction pipeline in which the reconstructor 120 synthesizes novel views and renders scene images based on the estimated parameters and criteria for motion. The reconstructor 120 at the reconstructor stage can apply a scene reconstruction using the image rendering model to render the estimated image for one or more viewpoints and temporal intervals based on the plurality of images of the scene. That is, the reconstructor 120 can use the refined parameters from the image rendering model to generate new views of the scene that match (or closely resemble) the defined spatial and temporal constraints. Additionally, Equation(s) 1-3 can be used to model elements of the scene and temporal positions for the rendering process. For example, the reconstructor 120 can synthesize novel views using criteria for motion or fill gaps (e.g., between the existing images). In this example, the reconstructor 120 can output new images based on input data and predicted motion fields.

Additionally, the reconstructor 120 can be configured to generate multi-view reconstructions that align with the input images and satisfy the scene constraints. The reconstructor stage can produce outputs that are visually consistent and accurately represent the dynamic changes in the scene. For example, the reconstructor 120 can create images for viewpoints not present in the input data, filling in missing information based on the model predictions. In this example, Equation(s) 1-3 can be used to calculate the positions of scene elements over time for accurate rendering. For example, the reconstructor 120 can apply learned models to refine the scene reconstructions based on observed data.

In some implementations, the reconstructor 120 can maintain, execute, train, and/or update one or more machine-learning models as part of (and/or implementing) the reconstructor stage. For example, the image rendering model can include at least one of (i) a Gaussian splatting model or (ii) a neural radiance field (NeRF) model. It should be understood that the pipeline and modeling framework can support any learnable rendering model by integrating priors at the rendered image level, without being limited to Gaussian splatting or NeRF models and without constraining to specific rendering techniques. For example, various modeling frameworks can be used such as, but not limited to, voxel-based models, point cloud models, implicit neural representations, surface light field models, and/or any other rendering models that can utilize learnable parameters for image synthesis. In some implementations, the machine-learning model(s) can include any type of model capable of generating scene reconstructions based on estimated parameters. For example, the machine-learning model(s) can be trained and/or updated to learn reconstruction parameters that output realistic scene images. The machine-learning model(s) can be or include a transformer-based model (e.g., a generative pre-trained transformer (GPT) model), a convolutional neural network (CNN) for learning image synthesis, a recurrent neural network (RNN) for capturing temporal coherence in image sequences, or any graph neural network (GNN) for learning relationships between scene elements. The machine-learning model(s) can be or include a variational autoencoder (VAE) model in some implementations. The reconstructor 120 can execute the machine-learning model to generate outputs (e.g., novel view images, scene interpolations, or refined reconstructions). Reconstructor 120 can receive data or identify a trained/updated model (e.g., an image rendering model, trained/updated using the image estimator 108, motion modeler 112, and/or loss modeler 116) to perform one or more inference actions or tasks. For example, the received data (e.g., motion fields, image parameters) can be provided as input to the image rendering model (e.g., machine-learning model(s)), which can include refined model parameters for generating new images.

The reconstructor 120 can include any one or more artificial intelligence models (e.g., machine learning models, supervised models, neural network models, deep neural network models), rules, heuristics, algorithms, filters (e.g., Kalman filters), functions, or various combinations thereof to perform operations including scene reconstruction, novel view synthesis, and image rendering, such as creating scene images based on the estimated model parameters. In some implementations, the reconstructor 120 can be trained/updated independently from other systems or devices described herein (e.g., image estimator 108, motion modeler 112, and/or loss modeler 116). In some implementations, training of the at least one reconstructor 120 can be at least partially performed jointly with the training of the image estimator 108, motion modeler 112, and/or loss modeler 116.

In some implementations, the reconstructor 120 can output a scene reconstruction to render an estimated image for one or more viewports and temporal intervals. For example, the reconstructor 120 can generate novel views of the scene based on the parameters and motion fields provided by other systems in the pipeline. For example, the reconstructor 120 can create interpolated images for missing or occluded views. In some implementations, the scene reconstruction can be provided to the other systems or devices described herein. That is, the application 124 can use the rendered scene images for further processing or visualization in various contexts. For example, the application 124 can apply the rendered images in virtual reality systems, autonomous navigation, or any other context implementing dynamic scene representations.

The system 100 can include at least one application 124. The application 124 can be a downstream device or system that can utilize the rendered scene images generated by the reconstructor 120 for various tasks or functionalities. In some implementations, the application 124 can process or analyze the rendered images to extract information, generate visualizations, and/or support decision-making processes. For example, the application 124 can be configured to operate in an autonomous navigation system that uses the reconstructed scenes to determine object trajectories or environmental changes for path planning. For example, the application 124 can be integrated into an augmented reality system to overlay dynamic scene elements onto a view of the user based on the reconstructed images. The application 124 can also integrate the rendered scenes into simulation environments, virtual reality (VR) platforms, and/or any other system outputting or inputting high-quality visual data of dynamic scenes. That is, the application 124 can be or include an interface for utilizing the output of the image rendering pipeline in operation. In some implementations, the application 124 can receive updates from the reconstructor 120 and adjust its processing based on refined scene data. For example, the application 124 can apply the rendered images in virtual reality systems, autonomous navigation, robotic vision, augmented reality systems, medical imaging, industrial automation, security surveillance, digital content creation, gaming environments, cinematic visual effects, and/or any other implementation including dynamic scene representations.

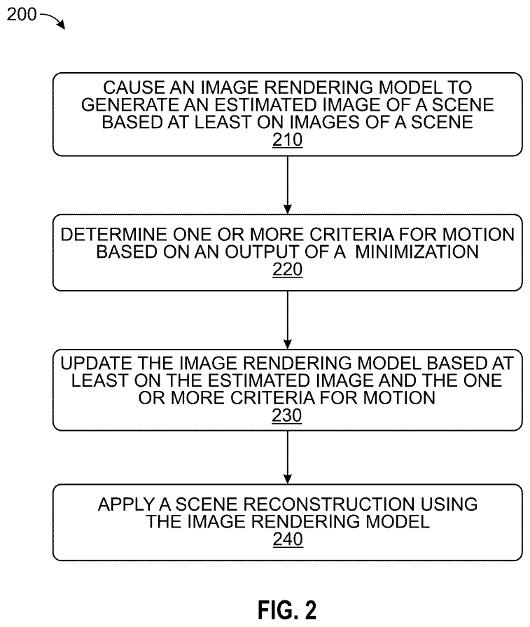

With reference to FIG. 2, an example flow diagram illustrating a method for dynamic novel view reconstruction based at least in part on flow rematching is depicted, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location.

Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram illustrating a method 200 for generating, updating, and applying an image rendering model based on estimated images and motion criteria, in accordance with some implementations of the present disclosure. Various operations of method 200 are directed toward improving the accuracy and computational efficiency of dynamic scene reconstruction pipelines by integrating flow rematching techniques and iterative refinement of motion fields. Existing systems typically use static representations or predefined deformation models, which can result in inaccuracies when managing complex scenarios involving variable motion patterns and dynamic object interactions. Such technical limitations can occur when conventional systems are unable to accurately model motion or deformation fields, resulting in visual distortions, increased latency, and inefficient utilization of computational resources. Method 200 and the systems described in FIG. 2 address these issues by implementing a dynamic reconstruction process that evaluates and updates the image rendering model based on learned motion criteria, such as velocity fields, to iteratively refine scene representations in real-time (or near real-time). This improves the output of the rendering model in representing complex deformations and motion dynamics, thereby improving the accuracy and computational efficiency of the scene reconstruction pipeline.

The method 200, at block 210, includes causing an image rendering model to generate an estimated image of a scene based at least on images of a scene. That is, at least one image of the plurality of images can be associated (e.g., captured from different temporal perspectives) with at least one of a different time (e.g., at t₁ representing an initial state of the scene, at t₂ representing a subsequent state showing motion)) or a different view (e.g., different camera positions d₁ and d₂ to capture varying viewpoints). In some implementations, the plurality of images of the scene can include a plurality of multi-view images. For example, the plurality of multi-view images can correspond to a plurality of different viewpoints captured at a plurality of different time points. In this example, capturing the multi-view images at different times provides the data used in defining the velocity fields that describe motion between the view.

The method 200, at block 220, includes determining one or more criteria for motion based on an output of a minimization. That is, the processing circuits can determine the one or more criteria for motion based on an output of a minimization. Generally, the one or more criteria for motion can correspond to a machine learning (ML) model trained/updated to generate one or more deformations of the estimated image based on parameters derived from one or more historical scenes. That is, the processing circuits can determine a velocity field directly from the constraints or learned models (e.g., without performing a flow integration), avoiding the computational overhead associated with integrating velocity fields over time. In some implementations, the learnable model can be trained/updated on parameters of previously captured dynamic scenes to learn how to generate realistic deformations of an estimated image. For example, during the training phase, the processing circuits can extract features such as object trajectories, velocity fields, and deformation patterns from labeled datasets of dynamic scenes to build a predictive model. Additionally, during the inference phase at block 220, the processing circuits can use the trained/updated model to generate expected motion criteria for captured scenes (e.g., newly captured and/or historically captured) based on visual input. For example, the processing circuits can input multi-view images of the scene to the model, which can output predicted velocity fields that describe the expected motion.

The criteria for motion can include one or more velocity fields representing a plurality of deformations in space over time (e.g., defining deformation in space over time, which can be constraints or criteria for how motion is represented in the scene reconstruction). For example, the processing circuits can determine a velocity field that represents a rigid transformation of an object (e.g., rotation without deformation). For example, the processing circuits can determine a velocity field that captures smooth deformation of a flexible object. In some implementations, the processing circuits can employ a minimization problem that can satisfy constraints of one or more functions (e.g., e.g., cost, loss, or objective function). In this example, Equation(s) 5 and 6 can be used to define and constraint the velocity fields according to rigidity and continuity conditions. The constraints of the one or more functions can satisfy (e.g., criteria that guide the dynamic reconstruction of the scene) the at least one of: (i) the rigidity constraint, (ii) the continuity constraint, and/or (iii) a constraint derived from the ML model. That is, the rigidity constraint can limit changes in the shape of objects over time. For example, the rigidity constraint can affect (e.g., by restricting non-linear deformations, enforcing rotation and translation only) how velocity fields are interpreted, such as specifying that the movement of objects should not result in a change of shape. Additionally, the continuity constraint assumes (e.g., by ensuring gradual changes in velocity fields) smooth transitions in object motion(s) within the scene. For example, the continuity constraint can affect how velocity fields are interpreted, such as specifying the velocity field must represent smooth transitions in object motion(s).

The method 200, at block 230, includes updating the image rendering model based at least on the estimated image (e.g., visual data) and the one or more criteria for motion (e.g., velocity fields and/or flows). In some implementations, the image rendering model can include at least one of (i) a Gaussian splatting model and/or (ii) a neural radiance field (NeRF) model. For example, the Gaussian splatting model can be trained/updated to represent the scene by projecting three-dimensional (3D) points onto a two-dimensional (2D) plane using one or more Gaussian functions. In this example, the processing circuits can calculate Gaussian splat parameters, such as center positions and covariances, using Equations 12 and 13, to update the image rendering model. For example, the NeRF model can be trained/updated to synthesize novel views of the scene from multiple 2D images by learning a continuous volumetric scene function. In this example, the processing circuits can adjust the density and color fields within the NeRF model to fit the input images and motion criteria.

In some implementations, updating the image rendering model can include minimizing a reconstruction loss and a rematch loss. For example, the processing circuits (e.g., using and/or applying Equation(s) 10 and 11) can formalize a minimization problem to obtain v_{*} (e.g., the optimal velocity field aligning with the Gaussian center motion u{dot over (()}t)). In this example, the processing circuits can rematch v_{*} to a reconstruction model to match the velocity to obtain a rematch loss. That is, v_{*} can represent the optimal deformation field and the rematch v_{*} can minimize discrepancies between predicted and observed motion paths. Equation(s) 7-9 can be used to match u to the flow derived from v_{*}. For example, the processing circuits can use Equations 7-9 to optimize u such that it represents the expected dynamics of the scene based on v_{*}. In this example, the rematch loss can be evaluated to ensure that u aligns (e.g., with consistent velocity patterns, adhering to rigidity and/or continuity) with the reconstructed motion model parameters. In some implementations, the reconstruction loss can correspond to a measure of discrepancy between the estimated image and the plurality of images of the scene (e.g., ground truths). In some implementations, the rematch loss can correspond to a measure of deviation between the estimated image and the one or more criteria for motion associated with an image flow (e.g., used as criterion for determining motion in the scene reconstruction).

In some implementations, the processing circuits can update the image rendering model based at least on the estimated image, the plurality of images, and/or one or more criteria for motion associated with the estimated image. That is, the criteria for motion can be represented by a velocity field (e.g., including physical prior (rigidity), continuity constraint, learnable model, piecewise rigid motion, volume-preserving deformation, or any learned dynamic flow model). In some implementations, updating the image rendering model can include the processing circuits determining and analyzing a first loss (e.g., L_{REC}) associated with analyzing (e.g., comparing) estimated images with ground truth information and/or a second loss (e.g., L_{RM}) associated with analyzing (e.g., matching) image flows represented in estimated images with constraints on an image flow. That is, to update the image rendering model the processing circuits can perform gradient-based optimization to minimize both the reconstruction and rematch losses simultaneously (or sequentially). For example, the first loss can be determined based on the pixel-wise difference between the estimated and ground truth images. In this example, the second loss can be determined based on the difference between the reconstructed flow and the expected flow given by the velocity fields v_{*}. That is, the processing circuits can evaluate or combine the first loss and the second loss to iteratively update the model parameters.

In some implementations, updating the image rendering model can include rematching a velocity field generated from the estimated image with a prior velocity field corresponding with the scene. That is, the operation of rematching can occur between the generated velocity field (e.g., part of the estimated image) and a prior velocity field. For example, to rematch, the processing circuits can use Equation 15 to obtain v_{*}, by minimizing the squared difference between the predicted and true Gaussian center velocities. Additionally, the criteria for motion can include comparing and adjusting the velocity fields to refine the dynamic reconstruction. For example, the processing circuits can iteratively adjust (or update) the velocity field v to facilitate consistency with the motion constraints, such as rigidity or continuity. In this example, the updated fields can be used to refine the rendered scene representation for improved accuracy in dynamic reconstructions. For example, the processing circuits can use the optimized v_{*} to rematch the predicted motion to the observed scene dynamics.

In some implementations, the L_{REC} at block 230 can be determined by modeling the difference between the estimated image generated by the image rendering model and the ground truth images of the scene. The loss can quantify how accurately the rendering model represents the visual appearance of the scene, accounting for various factors (e.g., color, brightness, and/or spatial structure). In some implementations, if the rendering model is based on a Gaussian splatting representation, the reconstruction loss can be computed as the pixel-wise mean squared error (MSE) between the rendered image Iₑₛₜ(p) and the ground truth image I_{gt}(p):

$${L}_{REC} = {\sum }_{p} {‖ {I}_{est} ( p ) - {I}_{gt} ( p ) ‖}^{2}$$

where p can be the pixel locations in the image. The loss function can penalize discrepancies between the rendered and ground truth images, guiding the model to produce images that resemble the real scene.

In a NeRF model, the reconstruction loss can be modeled by comparing the predicted color and density values along rays sampled from the scene with the observed color values in the input images. For example, the processing circuits can integrate the predicted scene function along at least one (e.g., each) ray to produce a synthesized image, and then determine the MSE between the synthesized and ground truth images.

In some implementations, to determine the NeRF reconstruction loss the processing can apply:

$${L}_{REC} = {\sum }_{r ∈ R} {‖ {C}_{est} ( p ) - {C}_{gt} ( p ) ‖}^{2}$$

where r can be a ray passing through a pixel in the image, R can be a set of rays corresponding to the pixels in the image, Cₑₛₜ(r) can be a color of the pixel estimated by the NeRF model along ray r, and C_{gt}(r) can be the ground truth color of the pixel along ray r.

In some implementations, Cₑₛₜ(r) can be determined by integrating the colors and densities along the ray:

$${C}_{est} ( r ) = {\sum }_{i = 1}^{N} {T}_{i} ( 1 - exp ( - {σ}_{i} {δ}_{i} ) ) {c}_{i}$$

where

$${T}_{i} = exp ( - {\sum }_{j = 1}^{i - 1} {σ}_{i} {δ}_{i} )$$

can be the accumulated transmittance up to point i, σᵢ can be the density at the i-th point, δᵢ can be the distance between adjacent sampled points, and cᵢ can be the RGB color at the i-th point.

At block 230, the processing circuits can facilitate gradient-based optimization to minimize the reconstruction loss L_{REC} with the rematch loss L_{RM} to refine the image rendering model to output visually accurate images that adhere to the expected motion dynamics. In some implementations, when ground truth motion is available, v_{*} can be used to directly compare the reconstructed motion to the actual dynamics, minimizing the rematch loss using known reference data. In some implementations, when model-constrained motion is used, u can be optimized to align with the predefined constraints, such as constraints derived from physical priors or learned models. It should be understood that v_{*} can be determined (or modeled) when true motion or deformation path of the scene elements is known or can be accurately estimated from external data sources. That is, v_{*} can be used when it represents the known motion or deformation path of the scene elements, which the model can match. The rematch loss can be calculated as:

$${L}_{RM} = \int \int {‖ {v}_{*} ( μ , t ) - \dot{μ} ‖}^{2} d μ dt$$

where the loss can measure the alignment of the candidate field v (from the model) with the true velocity field v_{*}.

It should be also understood that u can be determined (or modeled) when attempting to satisfy constraints derived from the dynamic model (e.g., rather than matching a true reference flow). That is, u can be used when it represents the candidate flow that aligns with priors or constraints defined by the scene reconstruction model. The rematch loss can be calculated as:

$${L}_{RM} ( U ) = {\int }_{0}^{1} ρ ( u ( \cdot , t ) , {ψ}_{t} ) dt$$

where ρ measures how well u fits within the constraints ψₜ defined by the dynamic model (e.g., rather than matching a true or reference flow).

The method 200, at block 240, includes applying a scene reconstruction using the image rendering model. In some implementations, the processing circuits can apply a scene reconstruction using the image rendering model to render the estimated image for one or more viewpoints and temporal intervals based on the plurality of images of the scene. That is, the processing circuits can synthesize novel views using criteria for motion to fill gaps (e.g., between the existing images, such as missing perspectives, occluded views). To apply scene reconstruction, the processing circuits can use the updated image rendering model to generate synthesized views of the scene. That is, the processing circuits can use the learned motion criteria, such as velocity fields v_{*}, to refine the scene representation. The processing circuits can optimize the image rendering model by adjusting parameters (e.g., Gaussian splat centers, NeRF density fields) to reduce discrepancies between the synthesized images and the input images of the scene. For example, a downstream application such as autonomous vehicle navigation can use the reconstructed scenes to improve path planning and obstacle detection based on the dynamic environment. Additionally, the scene can be reconstructed using the updated image rendering model to output a temporally consistent sequence of images representing the dynamic scene evolution. For example, the reconstructed sequence can be used for creating experiences in virtual or augmented reality applications by providing realistic motion and depth cues.

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

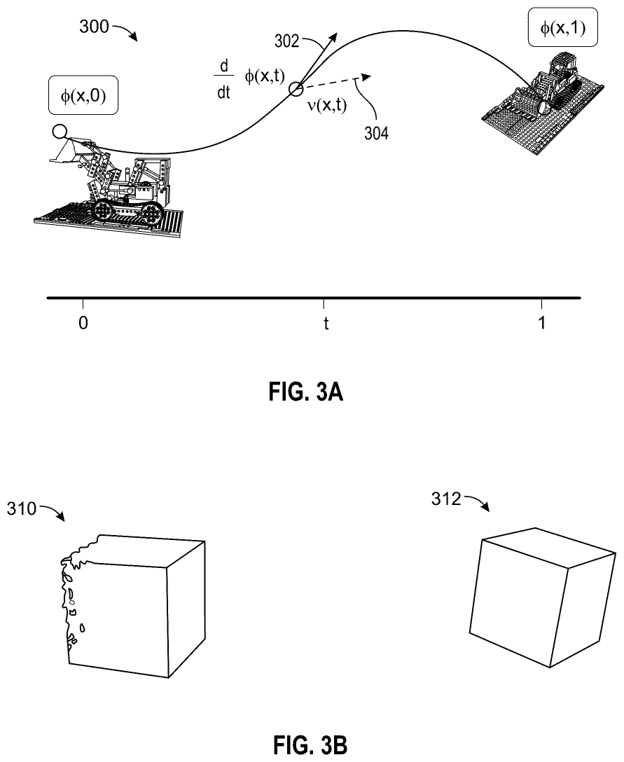

With reference to FIG. 3A, FIG. 3A is an example of flow rematching using velocity fields, in accordance with some implementations of the present disclosure. The flow rematching 300 can represent the deformation of an object over time, where φ(x,0) can be the initial position of the object at time t=0. As the object moves along the path defined by φ(x,t), the velocity field v(x,t) can indicate the instantaneous velocity (e.g., direction and magnitude of the motion) of the object at time t. At a specific point along the trajectory, indicated as 302, the instantaneous rate of change of position, or the tangent to the curve, can be determined by the derivative

$$\frac{d}{dt} ( ϕ ( x , t ) ) .$$

That is, vector 304 can represent the predicted direction and magnitude of the motion described by v(x,t). The velocity field v(x,t) can describe the continuous transformation of the position of the object in space over time. The rematching process can be used to align the modeled velocity field v(x,t) with the observed flow of the object, ensuring that the trajectory φ(x,t) accurately captures the motion dynamics of the scene. At time t=1, the position of the object can be represented by φ(x,1).

With reference to FIG. 3B, FIG. 3B is an example rendering of flow rematching using velocity fields, in accordance with some implementations of the present disclosure. The 3D box 310 represents a scene reconstructed using a typical Gaussian splatting technique, which can result in pixelated and poorly rendered outputs due to its limited ability to capture complex deformations and motion dynamics. In contrast, the 3D box 312 represents the same scene rendered using the above described reconstruction pipeline, incorporating dynamic flow rematching techniques that can optimize the velocity fields and Gaussian parameters over time.

### Example Language Models

In at least some implementations, language models, such as large language models (LLMs), vision language models (VLMs), multi-modal language models (MMLMs), and/or other types of generative artificial intelligence (AI) can be implemented. Generally, the language models can be used to implement and train the models of the image estimator 108, motion modeler 112, loss modeler 116, and/or reconstructor 120 described above. That is, the reconstruction pipeline can incorporate one or more models to generate, modify, and interpret scene representations based on the estimated parameters and criteria for motion. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models can be considered “large,” in implementations, based on the models being trained/updated on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in some implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs-such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in some implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained/updated using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained/updated to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained/updated on different (e.g., updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 4A is a block diagram of an example generative language model system 400 suitable for use in implementing at least some implementations of the present disclosure. Generally, the example generative language model system 400 can include components, such as the image estimator 108, motion modeler 112, loss modeler 116, and/or reconstructor 120, which can implement and train models of a dynamic scene reconstruction pipeline. That is, the system 400 can be used to deploy and manage the training of generative models by these components. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a VLM, a multi-modal LM, etc.).

At a high level, the input processor 405 can receive an input 401 including text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/VLM/MMLM/etc.). In some implementations, the input 401 includes plain text in the form of one or more sentences, paragraphs, and/or documents. Additionally or alternatively, the input 401 can include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 can combine text (or can omit text) with image data, audio data, video data, design data, USD data, and/or other types of input data, such as but not limited to those described herein. Taking raw input text as an example, the input processor 405 can prepare raw input text in various ways. For example, the input processor 405 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or or handling special cases like contractions or abbreviations to ensure consistency. These are just a few examples, and other types of input processing can be applied.

In some implementations, a RAG component 492 (which can include one or more RAG models, and/or can be performed using the generative LM 430 itself) can be used to retrieve additional information to be used as part of the input 401 or prompt. RAG can be used to enhance the input to the LLM/VLM/MMLM/etc. with external knowledge, so that answers to specific questions or queries or requests are more relevant—such as in a case where specific knowledge is required. The RAG component 492 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 401 can be generated using the query or input to the model (e.g., a question, a request, etc.) in addition to data retrieved using the RAG component 492. In some implementations, the input processor 405 can analyze the input 401 and communicate with the RAG component 492 (or the RAG component 492 can be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The RAG component 492 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 492 and the embeddings of the chunks along with the embeddings of the query can be compared to identify the most similar/related embeddings to the query, which can be supplied to the generative LM 430 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. For example, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 492 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in's REST interface such that the graph database is decoupled from the vector database and/or the embeddings models.

The tokenizer 410 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy can depend on factors such as the language being processed, the task at hand, and/or characteristics of the training dataset. As such, the tokenizer 410 can convert the (e.g., processed) text into a structured format according to tokenization schema being implemented in the particular implementation.

The embedding component 420 can use any known embedding technique to transform discrete tokens into (e.g., dense, continuous vector) representations of semantic meaning. For example, the embedding component 420 can use pre-trained/updated word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 can resize the data to a standard size compatible with format of a corresponding input channel and/or can normalize pixel values to a common range (e.g., 0 to 1) to ensure a consistent representation, and the embedding component 420 can encode the image data using any known technique (e.g., using one or more convolutional neural networks (CNNs) to extract visual features). In some implementations in which the input 401 includes audio data, the input processor 401 can resample an audio file to a consistent sampling rate for uniform processing, and the embedding component 420 can use any known technique to extract and encode audio features-such as in the form of a spectrogram (e.g., a mel-spectrogram). In some implementations in which the input 401 includes video data, the input processor 401 can extract frames or apply resizing to extracted frames, and the embedding component 420 can extract features such as optical flow embeddings or video embeddings and/or can encode temporal information or sequences of frames. In some implementations in which the input 401 includes multi-modal data, the embedding component 420 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some implementations, the generative LM 430 can be configured to access or use—or capable of accessing or using—plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RAG component 492, but also on the expertise or optimized nature of one or more external resources—such as the plug-ins/APIs 495. FIG. 4B is a block diagram of an example implementation in which the generative LM 430 includes a transformer encoder-decoder.

Generally, the generative LM 430 can facilitate the implementation and training of models for the image estimator 108, motion modeler 112, loss modeler 116, and/or reconstructor 120. That is, the generative LM 430 can be used to develop and train models that the above components can execute for processing input data, estimating motion, and performing dynamic scene reconstructions based on the generated outputs. For example, assume input text such as “Who discovered gravity” is tokenized (e.g., by the tokenizer 410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 440 can convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier including one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token based on a corresponding predicted probability (e.g., select the word with the highest predicted probability) and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response. The classifier 465 and the generation mechanism 470 can operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 5 is a block diagram of an example computing device(s) 500 suitable for use in implementing some implementations of the present disclosure. Generally, the example computing device(s) 500 can execute operations of the system 100, such as managing data processing and performing computations for dynamic scene reconstruction. That is, the computing device(s) 500 can execute instructions to process multi-view images, determine criteria for motion, and update the image rendering model based on input data and constraints. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can include one or more virtual machines (VMs), and/or any of the components thereof can include virtual components (e.g., virtual hardware components). For non-limiting examples, one or more of the GPUs 508 can include one or more vGPUs, one or more of the CPUs 506 can include one or more vCPUs, and/or one or more of the logic units 520 can include one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. For example, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that can be used in at least one implementations of the present disclosure. Generally, the example data center 600 can include hardware and software resources for processing, storing, and managing data for dynamic scene reconstruction. That is, the data center 600 can execute large-scale computations, manage data storage, and provide network access to support the training and inference operations of the image estimator 108, motion modeler 112, loss modeler 116, and reconstructor 120. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-6161(N) can include one or more virtual components, such as vGPUs, vCPUs, and/or the like, and/or one or more of the node C.R.s 616(1)-616(N) can correspond to a virtual machine (VM).

In at least one implementation, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one implementation, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark™ (hereinafter “Spark”) that can use distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained/updated by calculating weight parameters according to a neural network architecture using software and/or computing resources described above with respect to the data center 600. In at least one implementation, trained/updated or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in some ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
cause an image rendering model to generate an estimated image of a scene based at least on a plurality of images of the scene, at least one image of the plurality of images associated with at least one of a different time or a different view; and
update the image rendering model based at least on the estimated image, the plurality of images, and one or more criteria for motion associated with the estimated image.

2. The one or more processors of claim 1, wherein the one or more criteria for motion comprise a velocity field representing a plurality of deformations in space over time.

3. The one or more processors of claim 1, wherein updating the image rendering model further comprises rematching a velocity field generated from the estimated image with a prior velocity field corresponding with the scene.

4. The one or more processors of claim 1, wherein the one or more criteria for motion comprise at least one of: (i) a rigidity constraint that limits changes in shape of objects over time or (ii) a continuity constraint that assumes smooth transitions in object motion within the scene.

5. The one or more processors of claim 4, wherein the one or more criteria for motion correspond to a machine learning (ML) model updated to generate one or more deformations of the estimated image based on parameters derived from one or more historical scenes.

6. The one or more processors of claim 5, wherein the one or more processors comprising processing circuitry are to:
determine the one or more criteria for motion based at least on an output of a minimization of one or more functions satisfying the at least one of: (i) the rigidity constraint, (ii) the continuity constraint, or (iii) a constraint derived from the ML model.

7. The one or more processors of claim 1, wherein the image rendering model comprises at least one of: (i) a Gaussian splatting model or (ii) a neural radiance field (NeRF) model.

8. The one or more processors of claim 1, wherein the plurality of images of the scene comprises a plurality of multi-view images, wherein the plurality of multi-view images corresponds to a plurality of different viewpoints captured at a plurality of different time points.

9. The one or more processors of claim 1, wherein the processing circuitry is to:
apply a scene reconstruction using the image rendering model to render the estimated image for one or more viewpoints and one or more temporal intervals based on the plurality of images of the scene.

10. The one or more processors of claim 1, wherein updating the image rendering model comprises minimizing a reconstruction loss and a rematch loss, and wherein the reconstruction loss corresponds to a measure of discrepancy between the estimated image and the plurality of images of the scene, and wherein the rematch loss corresponds to a measure of deviation between the estimated image and the one or more criteria for motion associated with an image flow.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

12. A system, comprising:
one or more processors to execute operations comprising:
cause an image rendering model to generate an estimated image of a scene based at least on a plurality of images of the scene, at least one image of the plurality of images associated with at least one of a different time or a different view; and
update the image rendering model based at least on the estimated image, the plurality of images, and one or more criteria for motion associated with the estimated image.

13. The system of claim 12, wherein the one or more criteria for motion comprise a velocity field representing a plurality of deformations in space over time.

14. The system of claim 12, wherein updating the image rendering model further comprises rematching a velocity field generated from the estimated image with a prior velocity field corresponding with the scene.

15. The system of claim 12, wherein the one or more criteria for motion comprise at least one of (i) a rigidity constraint that limits changes in shape of objects over time or (ii) a continuity constraint that assumes smooth transitions in object motion within the scene, and wherein the one or more criteria for motion correspond to a machine learning (ML) model trained to generate one or more deformations of the estimated image based on parameters derived from one or more historical scenes.

16. The system of claim 15, wherein the one or more processors are to execute the operations comprising:
determine the one or more criteria for motion based at least on an output of a minimization of one or more functions satisfying the at least one of: (i) the rigidity constraint, (ii) the continuity constraint, or (iii) a constraint derived from the ML model.

17. The system of claim 12, wherein the image rendering model comprises at least one of (i) a Gaussian splatting model or (ii) a neural radiance field (NeRF) model.

18. The system of claim 12, wherein the plurality of images of the scene comprises a plurality of multi-view images, wherein the plurality of multi-view images corresponds to a plurality of different viewpoints captured at a plurality of different time points.

19. The system of claim 12, wherein the one or more processors are to execute the operations comprising:
apply a scene reconstruction using the image rendering model to render the estimated image for one or more viewpoints and one or more temporal intervals based on the plurality of images of the scene.

20. A method, comprising:
causing, using one or more processors, an image rendering model to generate an estimated image of a scene based at least on a plurality of images of the scene, at least one image of the plurality of images being associated with at least one of a different time or a different view; and
updating, using the one or more processors, the image rendering model based at least on the estimated image, the plurality of images, and one or more criteria for motion associated with the estimated image.
